(19) United States
(12) Patent Application Publication
(10) Pub. No.: US 2015/0198477 A1
(43) Pub. Date: Jul. 16, 2015

(54) DEVICE FOR DETECTING SINGLE PHOTON AVAILABLE AT ROOM TEMPERATURE AND METHOD THEREOF

(71) Applicant: KOREA INSTITUTE OF SCIENCE AND TECHNOLOGY, Seoul (KR)

(72) Inventors: Chulki KIM, Seoul (KR); Joon Hyong CHO, Seoul (KR); Yeong Jun KIM, Seoul (KR); Minah SEO, Seoul (KR); Seok LEE, Seoul (KR); Jong Chang YI, Seoul (KR); Jonghoo PARK, Daegu (KR); Byeong Ho PARK, Bucheon-si (KR); Deok Ha WOO, Seoul (KR); Sun Ho KIM, Seoul (KR); Jae Hun KIM, Seoul (KR); Taikjin LEE, Seoul (KR)

(73) Assignee: KOREA INSTITUTE OF SCIENCE AND TECHNOLOGY, Seoul (KR)

(21) Appl. No.: 14/210,684

(22) Filed: Mar. 14, 2014

(30) Foreign Application Priority Data
Jan. 16, 2014 (KR) 10-2014-0005506

(51) Int. Cl. G01J 1/04; G01J 1/42

(52) U.S. Cl. CPC G01J 1/0407; G01J 1/42

(57) ABSTRACT

Disclosed are a device for detecting a single photon available at a room temperature, which includes: a signal transmitting unit including a first electrode and a second electrode spaced apart from each other and at least one nanostructure disposed between the first electrode and the second electrode, the first electrode receiving a signal from the signal generating unit; a photonic crystal lattice structure for receiving a photon, the photonic crystal lattice structure having an optical waveguide for guiding the received photon to the first electrode, the optical waveguide being formed by a plurality of dielectric structures; and a single photon detector for detecting a photon by analyzing a signal output to the second electrode, and a method for detecting a single photon using the device.

### CROSS-REFERENCE TO RELATED APPLICATION

This application claims priority to Korean Patent Application No. 10-2014-0005506, filed on Jan. 16, 2014, and all the benefits accruing therefrom under 35 U.S.C. §119, the contents of which in its entirety are herein incorporated by reference.

### BACKGROUND

1. Field

The present disclosure relates to a device for detecting a single photon, and more particularly, to a device for detecting a single photon available at a room temperature by using a nanostructure making a pendulum movement between electrodes and a waveguide based on a photonic crystal structure.

2. Description of the Related Art

Generally, a device for detecting a single photon outputs electric signals proportional to the number of received photons even though its detection efficiency is low. Detecting devices for photon-number resolution, which are being currently studied, includes a superconducting tunnel junction (STJ) based detector, a quantum-dot field-effect transistor based detector, a superconducting nanowire based single photon detector, a superconducting transition edge sensor or the like. However, such detectors mostly operate at low temperature in order to avoid an unintended current flow at a room temperature, or cause a problem when there is no incident light (a dark count rate). In addition, low-temperature equipment demanded for creating a low-temperature circumstance has a large volume and requires great maintenance costs, which gives a great difficulty in its commercialization.

### RELATED LITERATURES

### Patent Literature

(Patent Literature 1) U.S. Pat. No. 8,378,895

### Non-Patent Literature

(Non-patent Literature 1) C. Weiss, W. Zwerger, Accuracy of a mechanical single electron shuttle, Europhys. Lett. 47, 97, (1999)
(Non-patent Literature 2) A. Erbe, C. Weiss, W. Zwerger, R. H. Blick, Nanomechanical resonator shuttling single electrons at radio frequencies, Phys. Rev. Lett. 87, 096106, (2001)
(Non-patent Literature 3) D. V. Scheible, R. H. Blick, Silicon nanopillars for mechanical single electron transport, Appl. Phys. Lett. 84, 4632, (2004)
(Non-patent Literature 4) D. V. Scheible, C. Weiss, J. P. Kotthaus, R. H. Blick, Periodic field emission from an isolated nanoscale electron island, Phys. Rev. Lett. 93, 186801, (2004)
(Non-patent Literature 5) H. S. Kim, H. Qin, R. H. Blick, Self-excitation of single nanomechanical pillars, New J. Phys. 12, 033008, (2010)
(Non-patent Literature 6) C. Kim, J. Park, R. H. Blick, Spontaneous symmetry breaking in two coupled nanomechanical electron shuttles, Phys. Rev. Lett. 105, 067204, (2010)
(Non-patent Literature 7) C. Kim, M. Prada, R. H. Blick, Coulomb blockade in a coupled nanomechanical electron shuttle, ACS Nano 6, 651, (2012)

### SUMMARY

The present disclosure is directed to providing a device for detecting a single photon, which may operate at a room temperature and have a low dark count rate when there is no light.

In one aspect, there is provided a device for detecting a single photon available at a room temperature, which includes: a signal transmitting unit including a first electrode and a second electrode spaced apart from each other and at least one nanostructure disposed between the first electrode and the second electrode, the first electrode receiving a signal from the signal generating unit; a photonic crystal lattice structure for receiving a photon, the photonic crystal lattice structure having an optical waveguide for guiding the received photon to the first electrode, the optical waveguide being formed by a plurality of dielectric structures; and a single photon detector for detecting a photon by analyzing a signal output to the second electrode.

In the device for detecting a single photon available at a room temperature according to an embodiment, the at least one nanostructure may be spaced apart from the first electrode and the second electrode, and an upper portion of the nanostructure may make a pendulum movement between the first electrode and the second electrode to transfer electrons from the first electrode to the second electrode.

In the device for detecting a single photon available at a room temperature according to an embodiment, the at least one nanostructure may include at least two nanostructures, and the at least two nanostructures may be arranged in series to be spaced apart from each other between the first electrode and the second electrode.

In the device for detecting a single photon available at a room temperature according to an embodiment, the at least two nanostructures may include a first nanostructure and a second nanostructure, an upper portion of the first nanostructure may make a pendulum movement between the first electrode and the second nanostructure to transfer electrons from the first electrode to the second nanostructure, and an upper portion of the second nanostructure may make a pendulum movement between the first nanostructure and the second electrode or another nanostructure to transfer electrons from the first nanostructure to the second electrode or another nanostructure.

In the device for detecting a single photon available at a room temperature according to an embodiment, the photonic crystal lattice structure may include a plurality of dielectric structures arranged in a lattice pattern, the plurality of dielectric structures may have a rod shape, and the optical waveguide may be formed by adjusting diameter and interval of the plurality of dielectric structures.

In the device for detecting a single photon available at a room temperature according to an embodiment, the photonic crystal lattice structure may include a plurality of dielectric structures arranged in a predetermined lattice pattern, the plurality of dielectric structures may include at least one first dielectric structure having a first dielectric constant and at least one second dielectric structure having a second dielectric constant, and a wavelength band of incident light may be determined by the first dielectric structure and the second dielectric structure disposed at predetermined locations.

In the device for detecting a single photon available at a room temperature according to an embodiment, the at least one nanostructure may include a silicon-on-insulator (SOI) substrate and a metal film layer formed on the SOI substrate.

In the device for detecting a single photon available at a room temperature according to an embodiment, the at least one nanostructure may have a diameter of 10 to 70 nm.

In the device for detecting a single photon available at a room temperature according to an embodiment, the single photon detector may calculate the presence of a received photon and the amount of received photons by analyzing an intensity of a signal provided by the signal generating unit and an intensity of a signal output to the second electrode.

In another aspect, there is also provided a method detecting a single photon available at a room temperature, which includes: forming a silicon-on-insulator (SOI) substrate; forming a metal film on the SOI substrate; and patterning the SOI substrate, on which the metal film is formed, to form a first electrode, a second electrode, at least one nanostructure located between the first electrode and the second electrode and a photonic crystal lattice structure located to surround a part of the first electrode, the photonic crystal lattice structure having an optical waveguide to guide a received photon to the first electrode.

The method for detecting a single photon available at a room temperature according to an embodiment may further include: inputting a photon to the photonic crystal lattice structure; measuring an intensity of a signal output from the second electrode by inputting a signal to the first electrode; and detecting an amount of received photons by analyzing intensities of the input signal and the output signal.

In the method for detecting a single photon available at a room temperature according to an embodiment, the patterning may include removing the metal film formed on the photonic crystal lattice structure.

In the method for detecting a single photon available at a room temperature according to an embodiment, the at least one nanostructure may have a rod shape, and a lower portion of the at least one nanostructure may be fixed and an upper portion of the at least one nanostructure may elastically make a pendulum movement to transmit a signal from the first electrode to the second electrode.

The device for detecting a single photon according to an embodiment of the present disclosure is available at a room temperature and may resolve a single photon. Therefore, the device of the subject invention may be applied as a photo sensor or a photo detector in an imaging device to allow high-resolution photographing in various fields such as a bio industry.

In addition, even though a field effect transistor (FET) for controlling the transfer of electrons by using an electric field has been used in the existing semiconductor market, if the device for detecting a single photon according to an embodiment of the present disclosure is used, a new-concept transistor for controlling the transfer of electrons by using photon energy may be developed. In particular, heat loss and current loss caused by interactions of electrons in a semiconductor substance may be converted into interaction of a single photon and a single electron, which may minimize the losses.

Moreover, recently as the interest in the quantum information technology is increasing, the single photon detection is being actively studied. In this point of view, the device for detecting a single photon according to an embodiment of the present disclosure may give an element technology for quantum computing whose operating rate is superior to existing techniques in security technology or other specific operations to give a new paradigm for security in national organization networks, financial or personal credit information communication, or the like.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic circuit diagram showing a device for detecting a single photon available at a room temperature according to an embodiment of the present disclosure;

FIG. 2 is a diagram showing a photonic receiving unit 100 according to an embodiment of the present disclosure;

FIGS. 3a to 3c are diagrams for illustrating an electron transfer mechanism of a signal transmitting unit according to an embodiment of the present disclosure;

FIG. 4 is an energy diagram between a first electrode and a second electrode;

FIG. 5 is an I-V graph for illustrating a single photon detection result according to an embodiment of the present disclosure; and

FIG. 6 is a process and measurement flowchart for illustrating a method for detecting a single photon available at a room temperature according to an embodiment of the present disclosure.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. In the drawings, like reference numerals denote like elements. However, in the description, details of well-known features and techniques may be omitted to avoid unnecessarily obscuring the presented embodiments. In addition, the shape, size and regions, and the like, of the drawing may be exaggerated for clarity and may not mean the actual dimension.

Hereinafter, embodiments of the present disclosure will be described in detail with reference to the drawings.

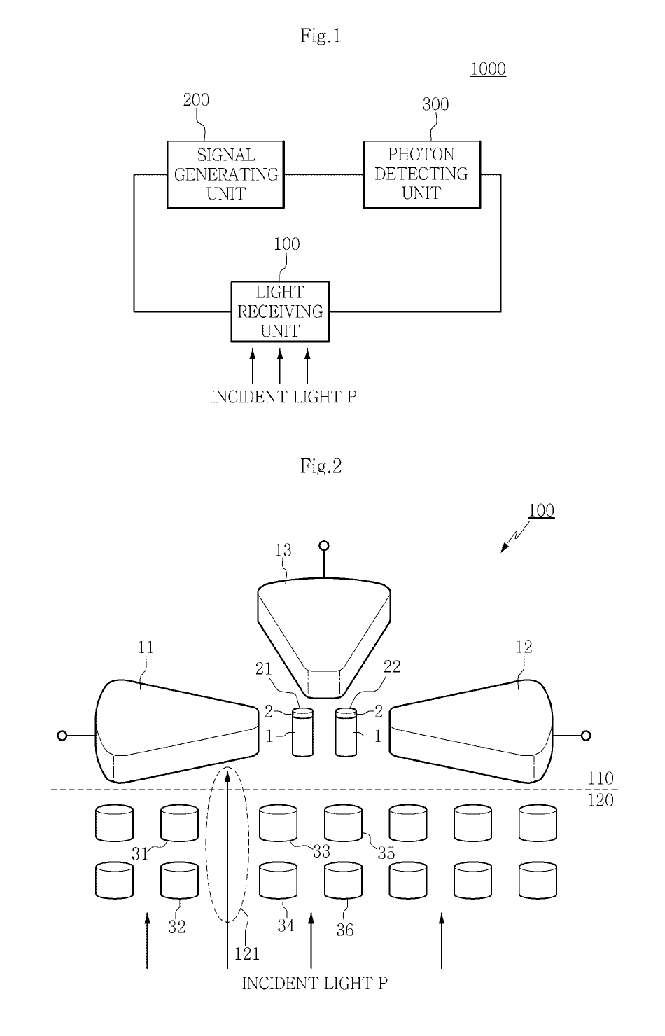

FIG. 1 is a schematic circuit diagram showing a device for detecting a single photon (hereinafter, also referred to as a single photon detecting device) available at a room temperature according to an embodiment of the present disclosure. The single photon detecting device 1000 of this embodiment includes a photonic receiving unit 100, a signal generating unit 200 and a single photon detector 300.

Referring to FIG. 1, a signal generated by the signal generating unit 200 is transmitted to the photonic receiving unit 100. The photonic receiving unit 100 receives the transmitted signal together with an incident light P input from the outside. Here, the photonic receiving unit 100 may include a light receiving unit for receiving light.

In addition, the photonic receiving unit 100 may change an intensity of the transmitted signal based on an intensity of the incident light and then output the signal. The output signal is transmitted to the single photon detector 300. The single photon detector 300 may detect the presence of incident light by using at least one of an intensity of the transmitted signal, an intensity of a signal firstly generated by the signal generating unit 200, and a characteristic of a material of the photonic receiving unit 100 (for example, an energy band gap) and then additionally calculate an amount of photons.

The term “signal” used in this specification may represent at least one of current, voltage, power and energy, and the incident light may be an artificial light transmitted from a light irradiating unit (not shown) included in the single photon detecting device 1000 or a light input from the outside like a solar ray. The light may be any light in various wavelength ranges, and its range is not limited.

FIG. 2 is a diagram showing a photonic receiving unit 100 according to an embodiment of the present disclosure. The structure depicted in FIG. 2 may have a nano scale, and this may be formed with a smaller size on occasions.

In an embodiment, the photonic receiving unit 100 may include a signal transmitting unit 110 and a photonic crystal lattice structure 120.

Referring to FIG. 2, the signal transmitting unit 110 includes a first electrode 11 and a second electrode 12 spaced apart from each other. In addition, the signal transmitting unit 110 includes at least one nanostructures 21, 22 disposed between the first electrode 11 and the second electrode 12. Even though FIG. 2 shows two nanostructures 21, 22, only a single nanostructure may be provided in another embodiment, and also three or more nanostructures may also be provided in still another embodiment. At least one nanostructures 21, 22 may be arranged in series between the first electrode and the second electrode. In addition, the nanostructures 21, 22 may have a diameter of 10 to 70 nm, specifically about 60 nm.

As shown in FIG. 2, the first electrode, the second electrode and the nanostructures do not contact each other but are spaced apart from each other by predetermined distances. In addition, the spaced area is in a vacuum state.

In an embodiment, at least one nanostructure may include a silicon-on-insulator (SOI) substrate 1 and a metal film layer 2 formed on the SOI substrate. The metal film may be made of any conductive material, specifically gold (Au).

Also in an embodiment, the first electrode and second electrodes may have a SOI substrate and a metal film layer as described above. In another embodiment, the first electrode and second electrodes may also be made of only a conductive material.

Referring to FIG. 2, the photonic crystal lattice structure 120 according to an embodiment receives an incident photon and includes an optical waveguide 121 for guiding the received photon to the first electrode. Here, the optical waveguide may be formed by a plurality of dielectric structures 31, 32, 33, 34. The dielectric structure may be made of silicon.

For example, the optical waveguide 121 may guide the received photon toward the first electrode 11 located near the nanostructure 21. Referring to FIG. 2, among the incident lights, the photon reaches the first electrode 11 only along the optical waveguide 121 and the other incident lights are blocked and not transmitted to the signal transmitting unit 110.

In an embodiment, the photonic crystal lattice structure 120 may be composed of a plurality of dielectric structures 31, 32, 33, 34, 35 . . . arranged in a lattice pattern. The dielectric structure having a lattice pattern gives an influence to a movement passage of electromagnetic wave (EM) passing through the dielectric structure and a wavelength band capable of passing through the dielectric structure. Based on this characteristic, in various embodiments of the present disclosure, the photonic crystal lattice structure 120 may form an optical waveguide for guiding a photon in a specific wavelength band to the first electrode by using the difference in dielectric constants of a plurality of dielectric structures and an arrangement of the dielectric structure.

In detail, a dielectric structure of a specific pattern in which dielectric substances having high dielectric constant and low dielectric constant are periodically arranged may block an electromagnetic wave of a specific wavelength band. The dielectric structure may have various patterns, for example a 1-D structure such as Bragg grating, a 2-D structure such as a holey fiber or a photonic crystal fiber, and a 3-D structure such as Yablonovite, a woodpile structure, inverse colloidal crystals, and two-dimensional crystals. In the embodiment of the present disclosure depicted in FIG. 2 employs the woodpile structure having a rod shape with the above periodic arrangement, but the present disclosure is not limited thereto.

In addition, since a part of the plurality of dielectric structures is configured to have a first dielectric constant and the other is configured to have a second dielectric constant, the electromagnetic wave (incident light) blocked by the photonic crystal lattice structure 120 is determined by the dielectric constants ∈1, ∈2, the radius of the structure d/2, and the period of the structure (a). The wavelength band of the blocked electromagnetic wave is called a photonic band gap, if a line defect for artificially cutting the period of the band gap and the dielectric structure is suitably used (as shown by a reference symbol 121 in FIG. 2) is suitably used, the electromagnetic wave moves along the defect portion. In other words, the line defect portion serves as an optical waveguide with a very small loss.

In detail, at this time, the photonic energy input to the first electrode 11 should interact with local electrons present at the surface of the first electrode, and for this, it is demanded to precisely control a path along which light moves. In order to design such a precise optical waveguide, the photonic crystal lattice structure 120 designs a photonic crystal which forms a photonic band gap at a specific wavelength and then forms a line defect in a region to which light is to be input, thereby guiding the light. The photonic band gap of the photonic crystal lattice structure is determined by diameter and interval of the dielectric structures of the photonic crystal lattice structure.

The photonic crystal lattice structure 120 uses a Maxwell equation like Equation 1 below to calculate the photonic band gap.

$$\{ ∇ \times \frac{1}{ε ( r )} ∇ \times \} H ( r ) = \frac{{ω}^{2}}{{c}^{2}} H ( r ) \qquad Equation 1$$

H(r) represents a photon electromagnetic field, w represents a frequency, c represents a light velocity, and ∈(r) represents an insulation function. If the insulation function has regular periodicity like a perfect PhC material, the function may be expressed with a frequency vector k and a band index n. A region allowable by all wavelength vectors is called a Brillouine zone, and a solution of this function may be expressed by a band structure. Therefore, a specific band structure may be formed by a specific radius d/2 of rods of the photonic crystal, a period structure (a), and a dielectric constant of the structure.

As described above, the photonic crystal lattice structure 120 gives light to the signal transmitting unit 110, and the signal transmitting unit 110 changes the intensity of the signal provided from the signal generating unit 200 based on the incident light and outputs the signal. Hereinafter, the light input to the signal transmitting unit 110 and operations of each component of the signal transmitting unit 110 will be described in detail.

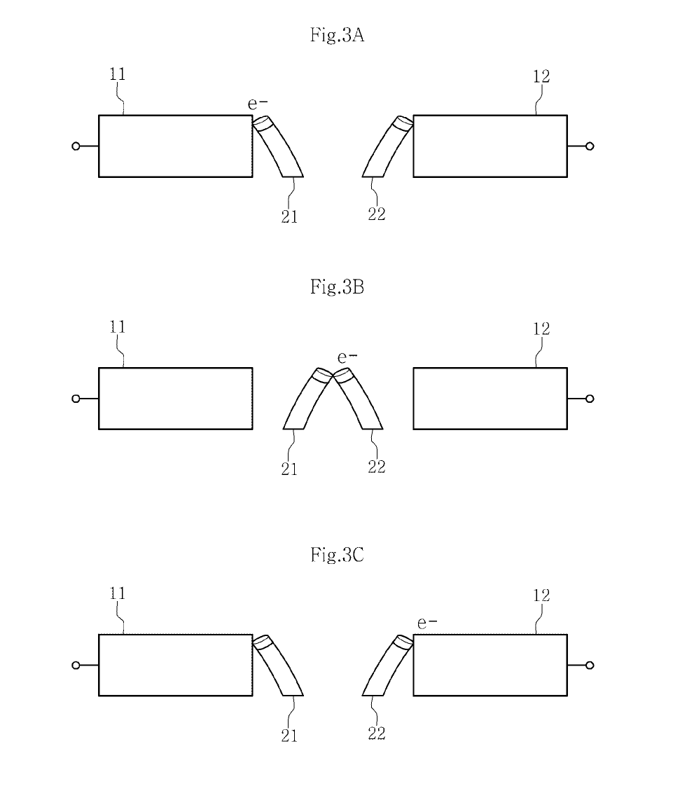

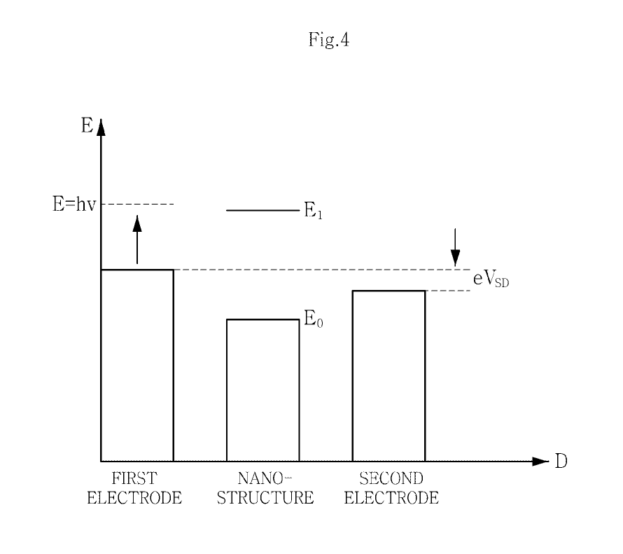

FIGS. 3a to 3c are diagrams for illustrating an electron transfer mechanism of a signal transmitting unit according to an embodiment of the present disclosure. Referring to FIGS. 3a to 3c, if a DC or AC voltage is applied to both electrodes 11, 12, the nanostructures 21, 22 may make a kinetic pendulum movement. Electrons (e-) of the first electrode 11 are transferred to the nanostructure 21 due to the pendulum movement (FIG. 3a), electrons are transferred to the nanostructure 22 due to the pendulum movement of the nanostructure 21 (FIG. 3b), and finally the second electrode 12 receives the electrons. By means of such an electron shuttle mechanism, the photonic receiving unit 100 may output the received signal. Even though FIGS. 3a to 3c show that two nanostructures are arranged in series, the present disclosure is not limited thereto, and a single nanostructure or three or more nanostructures may make a pendulum movement as described to above to transfer electrons from the first electrode to the second electrode.

In an embodiment, on the assumption that the potential between electrodes weakly depends on the location of the nanostructure, the pendulum movement of the nanostructure may be expressed like Equation 2 below by the classical mechanics.

$$\ddot{x} = - γ \dot{x} ( t ) - {ω}_{0}^{2} x ( t ) - \frac{q ( t ) V ( t )}{mL} \qquad Equation 2$$

In Equation 2, x represents a shift displacement of a nanostructure, y represents a damping constant, ω₀ represents an angular speed when the nanostructure oscillates with a natural frequency, q represents a charge amount of a film on the nanostructure, m represents a mass of the nanostructure, and L represents a distance between electrodes. A capacitance of each nanostructure is C≅4π∈₀r(1+(r/d)²), and a capacitance of a signal transmitting unit composed of two electron shuttles arranged in series has a smaller value by means of C⁻¹≈C₁⁻¹+C₂⁻¹. Due to the reduced capacitance as described above, the charging energy E_{C}=e²/2C increases further. If a voltage greater than a threshold voltage is applied to the nanostructure, electron shuttles start oscillating, and when the amplitude is maximized, the possibility of causing an electron tunneling phenomenon between the first electrode and the nanostructure 21 increases.

At this time, electrons present in the nanostructure may interact with electrons which will move in a source, which may cause a discontinuous electron transfer. In other words, the transfer of a single electron is restricted by the Coulomb blockade phenomenon. The charge amount (q (t)=−en (t), n represents the number of electrons, e represents a charge amount of electrons, 1.6*10⁻¹⁹C) at a metal film deposited onto the nanostructure varies along with time, and its variation rate may be expressed by Equation 3 below.

n=0→1: Γ_{FL}=|eV(t)/4E_{C}|Γ_{L}(x)Θ(V),Γ_{FR}=|eV(T)/4E_{C}|Γ_{R}(x)Θ(−V)

n=1→0:Γ_{TL}=|eV(t)/4E_{C}|Γ_{L}(x)Θ(−V),Γ_{TR}=|eV(t)/4E_{C}|Γ_{R}(x)Θ(V) Equation 3

In Equation 3, Γ_{R(L)}=[R_{R(L)}(x)C]⁻¹, and Θ(t) is a Heaviside function. In addition, FL, FR, TL and TR respectively represent from/to and left/right. In the single photon detecting device of this embodiment, the energy of an input photon transmits a charging energy of a single electron whose tunneling is restricted by the Coulomb blockade, thereby facilitating the tunneling phenomenon of the single electron and thus enables a current flow.

However, at least one nanostructure has so small capacitance enough to increase the charging energy greater than thermal energy at a room temperature, the Coulomb blockade phenomenon may occur due to interactions among electrons. In addition, due to repulsive force between electrons, for the transfer of electrons, a charging energy to overcome the repulsive force is demanded to the first electrode. This charging energy may be transmitted due to the voltage difference between electrodes or may be overcome by matching the potential of a nanostructure with a Fermi level of the electrodes by means of a gate voltage.

For example, referring to FIG. 2, if the first electrode 11 is as a source electrode, the second electrode 12 is as a drain electrode, and the third electrode 13 is as a gate electrode, the signal transmitting unit 110 may serve as a transistor.

In other case, as in an embodiment of the present disclosure, the repulsive force may be overcome by the energy of incident photons (by absorbing light energy having a specific energy) and the charging energy for transferring electrons may be filled. In the transfer of electrons based on a nanostructure making a pendulum movement, since the circumstance around the electron shuttle is in vacuum, a single electron may be controlled at a room temperature due to a low dielectric constant.

In detail, in a state where a voltage which does not overcome the charging energy is applied to the first electrode 11, when light having an energy whose intensity is equal to the charging energy deficient in the first electrode 11 is input, a single electron absorbing the light is transferred to an adjacent nanostructure 21 due to the tunneling effect. Based on this effect, electrons move as shown in FIG. 3.

FIG. 4 is an energy diagram between the first electrode and the second electrode. In order to transfer an electron (e-) present in the first electrode to a nanostructure at a room temperature, the electron should be in an energy state of E1 or above. In addition, the diameter of a metal film deposited onto the nanostructure and the interval between the electrode and the nanostructure may be determined so that electrons are not transferred to the nanostructure at a room temperature (heat energy present at a room temperature is ˜26 meV). Under these conditions, if the energy potential of the first electrode is raised by transmitting the photonic energy to the first electrode, electrons may be transferred to the nanostructure. Here, the diameter of the metal film (the nanostructure) and the distance between the nanostructure and the electrode may be suitably adjusted. In an embodiment, the diameter of the metal film and the distance between the nanostructure and the electrode may be respectively smaller than 70 nm and smaller than 20 nm.

In an embodiment, since the intensity of measured current is proportional to the number of input photons, the single photon detector 300 may calculate the number of photons (or, a relative intensity of incident light) from the intensity of measured current, by using the fact that the transfer of electrons is represented by the change of the intensity of current.

In detail, at this time, the photonic energy input to the first electrode 11 should interact with local electrons present at the surface of the first electrode, and for this, it is demanded to precisely control a path along which light moves. In order to design such a precise optical waveguide, the photonic crystal lattice structure 120 designs a photonic crystal which forms a photonic band gap at a specific wavelength and then forms a line defect in a region to which light is to be input, thereby guiding the light. The photonic band gap of the photonic crystal lattice structure is determined by diameter and interval of the dielectric structures of the photonic crystal lattice structure.

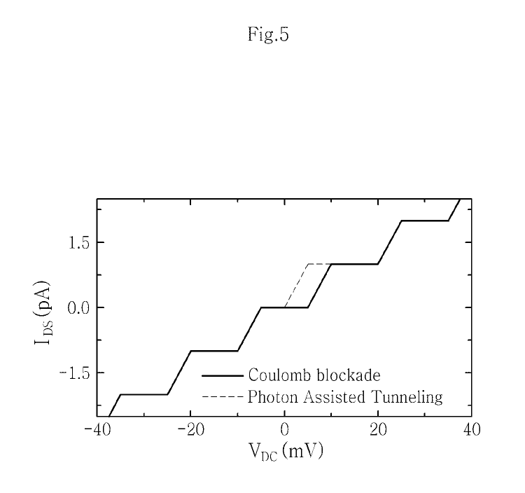

FIG. 5 is an I-V graph for illustrating a single photon detection result according to an embodiment of the present disclosure. In FIG. 5, a solid line represents a case in which photonic energy is not transmitted to the first electrode (case 1), and a dotted line represents a case in which the first electrode receives the photonic energy (case 2). In a region where the input voltage VDC is −5 to +5, in the case 1, there is substantially no change amount of current. In other words, since a charging energy enough to transfer electrons is not present at the first electrode, the current does not change. However, in the case 2, electrons are transferred by the photonic energy, thereby changing a current. The single photon detector 300 may check whether a photon is received based on the change pattern of current and may calculate an amount of photons based on an amount of additional current (about 0.75 in FIG. 5).

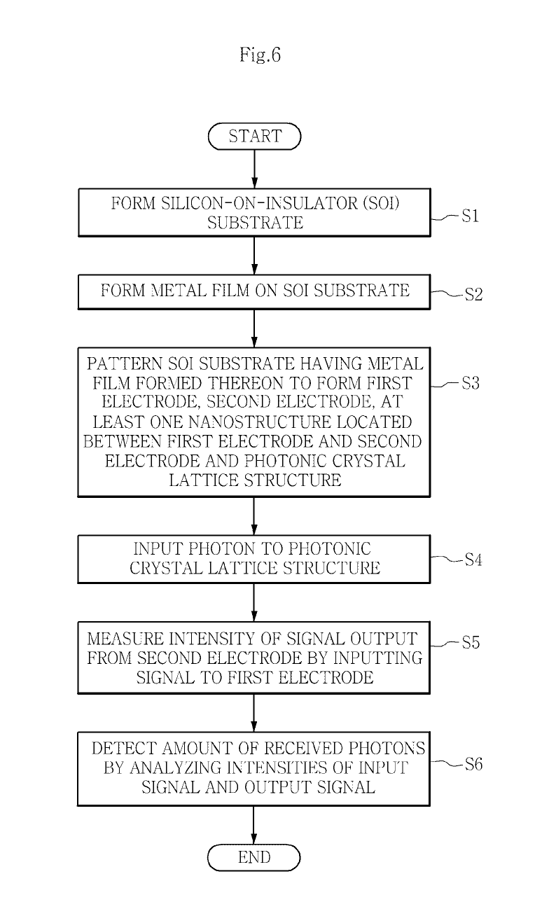

FIG. 6 is a process and measurement flowchart for illustrating a method for detecting a single photon (hereinafter, also referred to as a single photon detecting method) available at a room temperature according to an embodiment of the present disclosure. The single photon detecting method includes forming a silicon-on-insulator (SOI) substrate (S1), forming a metal film on the SOI substrate (S2), patterning the SOI substrate, on which the metal film is formed, to form a first electrode, a second electrode, at least one nanostructure located between the first electrode and the second electrode and a photonic crystal lattice structure located to surround a part of the first electrode, the photonic crystal lattice structure having an optical waveguide to guide a received photon to the first electrode (S3), inputting a photon to the photonic crystal lattice structure (S4), measuring an intensity of a signal output from the second electrode by inputting a signal to the first electrode (S5), and detecting an amount of received photons by analyzing intensities of the input signal and the output signal (S6).

In another embodiment, the single photon detecting method may include only the steps S1 to S3.

In detail, the process of forming a metal film (S2) may include patterning a probing band on the SOI substrate by means of a photolithography process, and depositing a metal film thereto.

In the patterning process (S3) may be performed by forming a polymethylmethacrylate (PMMA) layer, patterning a first electrode, a second electrode, nanostructure, and a plurality of photonic crystal lattice structures, depositing a metal film thereto, and etching by using the metal film as a mask. Here, the metal film formed on the photonic crystal lattice structure may be removed. For example, the element on which the metal film is deposited is put into a RIE chamber, and a silicon layer around the electrodes and the nanostructure is etched. In this case, an insulation layer (SiO₂) may also be etched to prevent a current leakage to the substrate.

In addition, the at least one nanostructure may have a rod shape. Moreover, a lower portion of the at least one nanostructure may be fixed and an upper portion of the at least one nanostructure elastically makes a pendulum movement to transfer an electrode from the first electrode to the second electrode.

It should be understood that the single photon detecting method may be performed using the functions of the components employed in the single photon detecting device, described above.

Though the present disclosure has been described with reference to the embodiments depicted in the drawings, it is just an example, and it should be understood by those skilled in the art that various modifications and equivalents can be made from the disclosure. However, such modifications should be regarded as being within the scope of the present disclosure. Therefore, the true scope of the present disclosure should be defined by the appended claims.

What is claimed is:

1. A device for detecting a single photon available at a room temperature, the device comprising:
a signal transmitting unit including a first electrode and a second electrode spaced apart from each other and at least one nanostructure disposed between the first electrode and the second electrode, the first electrode receiving a signal from the signal generating unit;
a photonic crystal lattice structure for receiving a photon, the photonic crystal lattice structure having an optical waveguide for guiding the received photon to the first electrode, the optical waveguide being formed by a plurality of dielectric structures; and
a single photon detector for detecting a photon by analyzing a signal output to the second electrode.

2. The device for detecting a single photon available at a room temperature according to claim 1,
wherein the at least one nanostructure is spaced apart from the first electrode and the second electrode, and
wherein an upper portion of the nanostructure makes a pendulum movement between the first electrode and the second electrode to transfer electrons from the first electrode to the second electrode.

3. The device for detecting a single photon available at a room temperature according to claim 1,
wherein the at least one nanostructure includes at least two nanostructures, and
wherein the at least two nanostructures are arranged in series to be spaced apart from each other between the first electrode and the second electrode.

4. The device for detecting a single photon available at a room temperature according to claim 3,
wherein the at least two nanostructures includes a first nanostructure and a second nanostructure,
wherein an upper portion of the first nanostructure makes a pendulum movement between the first electrode and the second nanostructure to transfer electrons from the first electrode to the second nanostructure, and
wherein an upper portion of the second nanostructure makes a pendulum movement between the first nanostructure and the second electrode or another nanostructure to transfer electrons from the first nanostructure to the second electrode or another nanostructure.

5. The device for detecting a single photon available at a room temperature according to claim 1,
wherein the photonic crystal lattice structure includes a plurality of dielectric structures arranged in a lattice pattern,
wherein the plurality of dielectric structures has a rod shape, and
wherein the optical waveguide is formed by adjusting diameter and interval of the plurality of dielectric structures.

6. The device for detecting a single photon available at a room temperature according to claim 1,
wherein the photonic crystal lattice structure includes a plurality of dielectric structures arranged in a predetermined lattice pattern,
wherein the plurality of dielectric structures includes at least one first dielectric structure having a first dielectric constant and at least one second dielectric structure having a second dielectric constant, and
wherein a wavelength band of incident light is determined by the first dielectric structure and the second dielectric structure disposed at predetermined locations.

7. The device for detecting a single photon available at a room temperature according to claim 1,
wherein the at least one nanostructure includes a silicon-on-insulator (SOI) substrate and a metal film layer formed on the SOI substrate.

8. The device for detecting a single photon available at a room temperature according to claim 1,
wherein the at least one nanostructure has a diameter of 10 to 70 nm.

9. The device for detecting a single photon available at a room temperature according to claim 1,
wherein the single photon detector calculates the presence of a received photon and the amount of received photons by analyzing an intensity of a signal provided by the signal generating unit and an intensity of a signal output to the second electrode.

10. A method detecting a single photon available at a room temperature, the method comprising:
forming a silicon-on-insulator (SOI) substrate;
forming a metal film on the SOI substrate; and
patterning the SOI substrate, on which the metal film is formed, to form a first electrode, a second electrode, at least one nanostructure located between the first electrode and the second electrode and a photonic crystal lattice structure located to surround a part of the first electrode, the photonic crystal lattice structure having an optical waveguide to guide a received photon to the first electrode.

11. The method for detecting a single photon available at a room temperature according to claim 10, further comprising:
inputting a photon to the photonic crystal lattice structure;
measuring an intensity of a signal output from the second electrode by inputting a signal to the first electrode; and
detecting an amount of received photons by analyzing intensities of the input signal and the output signal.

12. The method for detecting a single photon available at a room temperature according to claim 11,
wherein said patterning includes removing the metal film formed on the photonic crystal lattice structure.

13. The method for detecting a single photon available at a room temperature according to claim 10,
wherein the at least one nanostructure has a rod shape, and
wherein a lower portion of the at least one nanostructure is fixed and an upper portion of the at least one nanostructure elastically makes a pendulum movement to transmit a signal from the first electrode to the second electrode.
